(19) United States
(12) Patent Application Publication
(10) Pub. No.: US 2025/0045290 A1
(43) Pub. Date: Feb. 6, 2025

(54) TECHNIQUES FOR COMBINED DATA AND EXECUTION DRIVEN PIPELINE

(71) Applicant: Kebotix, Inc., Cambridge, MA (US)

(72) Inventors: Dennis Sheberla, Bedford, MA (US); Hengyu Xu, Lexington, MA (US)

(73) Assignee: Kebotix, Inc., Cambridge, MA (US)

(21) Appl. No.: 18/709,776

(22) PCT Filed: Nov. 22, 2022
(86) PCT No.: PCT/US2022/050675

§ 371 Date: May 13, 2024

Related U.S. Application Data
(60) Provisional application No. 63/282,584, filed on Nov. 23, 2021.

(51) Int. Cl. G06F 16/25; G06F 16/248

(52) U.S. Cl. CPC G06F 16/254; G06F 16/248

(57) ABSTRACT

A system is provided that obtains a specification of a data processing workflow comprising a plurality of processes, wherein each process is associated with input data and output data, and each process is further linked to one or more other processes of the workflow. The system may execute one or more processes of the workflow to generate a pipeline execution record that includes, for each of the one or more processes, input data, output data, execution metadata, or some combination thereof. The system may receive a workflow query, and use the workflow query to search the pipeline execution record for one or more processes of the data processing workflow that match the workflow query; and obtain output data associated with the one or more processes of the data processing workflow that match the workflow query. The pipeline execution record and the workflow query may be represented by a graph.

### CROSS-REFERENCE TO RELATED APPLICATIONS

This application claims the benefit of U.S. Provisional Application No. 63/282,584, filed Nov. 23, 2021, entitled, “TECHNIQUES FOR COMBINED DATA AND EXECUTION DRIVEN PIPELINE,” the entire content of which is incorporated herein by reference.

### BACKGROUND

Data processing workflow systems usually allow a user to manage the workflow, such that the user can set up the data processing workflow and store the workflow for retrieval and/or execution (e.g., via a database). To execute a workflow, the user must typically select input data (e.g., from a storage source) and trigger execution of the workflow using the input data. The workflow is then executed to generate output data.

### SUMMARY

The inventors have recognized and appreciated that improved workflow management systems and various applications using the improved workflow management systems can be devised. Such improved systems and methods in accordance with some embodiments employ computational and AI processes to utilize hardware requirements (in building a workflow) and allow users to control instrumentation and samples tracking in a variety of applications, e.g., in chemistry workflows. The systems and methods may store data passed between processes in association with one or more processes in the workflow. For example, a data processing workflow and data between the processes in the workflow may be stored in a graph database, as a pipeline execution record. The systems and methods enable the user to query the pipeline execution record in any suitable stage in the workflow by the structure of the workflow (e.g., a graph or a sub-graph as search query). The systems and methods provided herein are particularly advantageous over convention systems such that data and workflows, which are complex and dynamically changing, may be scaled up.

Some embodiments are directed to a system for workflow management, the system comprising at least one processor, the at least one processor is configured to: obtain a specification of a data processing workflow comprising a plurality of processes, wherein each process is associated with input data and output data, and each process is further linked to one or more other processes of the workflow; execute one or more processes of the plurality of processes of the workflow to generate, for each of the one or more processes, input data, output data, execution metadata, or some combination thereof; and generate a pipeline execution record, wherein the pipeline execution record comprises, for each of the one or more executed processes, a process data record comprising the associated input data, output data, execution metadata, or some combination thereof.

Some embodiments are directed to a method for workflow management, the method comprising, using at least one processor: obtaining a specification of a data processing workflow comprising a plurality of processes, wherein each process is associated with input data and output data, and each process is further linked to one or more other processes of the workflow; executing one or more processes of the plurality of processes of the workflow to generate, for each of the one or more processes, input data, output data, execution metadata, or some combination thereof; and generating a pipeline execution record, wherein the pipeline execution record comprises, for each of the one or more executed processes, a process data record comprising the associated input data, output data, execution metadata, or some combination thereof.

Some embodiments are directed to a non-transitory computer-readable media comprising instructions that, when executed, cause at least one processor to perform operations comprising: obtaining a specification of a data processing workflow comprising a plurality of processes, wherein each process is associated with input data and output data, and each process is further linked to one or more other processes of the workflow; executing one or more processes of the plurality of processes of the workflow to generate, for each of the one or more processes, input data, output data, execution metadata, or some combination thereof; and generating a pipeline execution record, wherein the pipeline execution record comprises, for each of the one or more executed processes, a process data record comprising the associated input data, output data, execution metadata, or some combination thereof.

### BRIEF DESCRIPTION OF THE DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1A is a diagram of a workflow management system for combined data and execution-driven pipeline, according to some embodiments.

FIG. 1B illustrates an example of search query for searching a data pipeline record by defining a graph search query, according to some embodiments.

FIG. 2A illustrates multiple processes in an example data processing workflow defined by a user, according to some embodiments.

FIG. 2B illustrates an example pipeline execution record associated with the data processing workflow of FIG. 2A, according to some embodiments.

FIG. 3A illustrates an example graphical user interface that may be implemented in a workflow management system, according to some embodiments.

FIG. 3B illustrates an example form builder that may be implemented in a workflow management system, according to some embodiments.

FIG. 4A illustrates multiple processes in an example map reduction data processing workflow, according to some embodiments.

FIG. 4B illustrates an example pipeline execution record associated with the data processing workflow of FIG. 4A, according to some embodiments.

FIG. 5 illustrates another example data processing workflow in which a portion of a data processing workflow includes a sub-workflow that includes one or more processes, according to some embodiments.

FIG. 6 illustrates a pipeline execution record associated with an example data processing workflow, according to some embodiments.

FIG. 7 illustrates a pipeline execution record associated with another example data processing workflow combined with machine learning training and prediction, according to some embodiments.

FIGS. 8A and 8B illustrate example architectures of a system that may implement one or more components of a system for combined data and execution-driven pipeline, according to some embodiments.

FIG. 9A illustrates an example application of molecule evaluation implemented in a data processing workflow, according to some embodiments.

FIG. 9B illustrates an example of pipeline execution record in a graph database resulting from an execution of the data processing workflow shown in FIG. 9A, according to some embodiments.

FIGS. 10A-10B illustrate an example graph database query based in part on a graph database resulting from an execution of a data processing workflow, according to some embodiments.

FIG. 11 illustrates examples of multiple molecule evaluation workflows in parallel, according to some embodiments.

FIG. 12 illustrates example process units of an example process in a data processing workflow, according to some embodiments.

FIG. 13 illustrates an example recursive data processing workflow, according to some embodiments.

FIG. 14 illustrates an example of reconfiguring a data processing workflow by adding one or more processes, according to some embodiments.

FIG. 15 illustrates an example application of sample tracking in a laboratory implemented in a data processing workflow, according to some embodiments.

FIG. 16 shows an illustrative implementation of a computer system that may be used to perform any of the aspects of the techniques and embodiments disclosed herein, according to some embodiments.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended.

Workflow management systems can be used to perform various tasks. In an example application, a data processing workflow can be created and/or configured in a workflow management system to perform certain functions, such as predicting properties of a molecule. A workflow can be executed multiple times, each time using different input data, such as the structure of a different molecule that can be processed to predict the properties of the molecule.

In conventional workflow systems, the input/output data is entirely decoupled from the workflow. While input data is specified for use with a pipeline (e.g., a flow of data through execution of a workflow or a portion of a workflow) in conventional approaches, the input data is not associated with either the pipeline or a particular execution of the pipeline (e.g., including the pipeline configuration for that execution, since the pipeline can change over time). Accordingly, the information for each particular execution of the pipeline is typically lost. Similarly, while the final output data can be saved, it would need to be manually associated with a particular pipeline, which is typically not done but even if done, it just stores the result of the processing pipeline—the output data is not associated with the input data and/or the particular pipeline configuration that was executed to generate the output data. Further, none of the data/metadata is stored throughout execution of each of the pipeline components in association with the pipeline components themselves. Therefore, conventional systems do not provide a record of a particular pipeline and its associated execution(s). Thus, it is not possible to use conventional approaches to retrieve at a particular pipeline configuration or execution of that pipeline to see what data was generated step-by-step in the execution of the pipeline. Furthermore, it would not be possible to look back at pipelines over time to see how they have changed, or to look at portions of previous pipeline configurations, or the data provided to/generated from those portions, etc. Additionally, each user is separately responsible for his/her own workflow and data, where no user can share other users' workflow and/or data thereof, or repeat a portion of other users' workflow.

Accordingly, the inventors have developed techniques for combining data and execution-driven pipelines. Described herein are various techniques, including systems, computerized methods, and non-transitory instructions, that integrate data with the pipeline workflow, where data passed by the processes in the workflow are stored in association with the workflow components (e.g., in a database).

An example data processing workflow may include a plurality of processes that are linked in certain configurations. Each of the one or more processes may be associated with respective input data and output data, and the plurality of processes may be linked, such that output data of one process may be provided as input to one or more other processes in the workflow. When the data processing workflow is executed, the data flows through the plurality of processes in the workflow as configured via the associated links.

A specification of a data processing workflow may include data describing the configuration of the plurality of processes in the data processing workflow, such as how the plurality of processes are linked. For example, the plurality of processes in a data processing workflow may be linked in serial, in parallel, or in a combination of serial and parallel manners. In some embodiments, a specification of a workflow may be represented in a digital representation, such as a specification file describing the workflow. For example, a specification file can be an XML file, a JSON file, a graph file, a flat file, and/or any other suitable format.

The techniques described herein can therefore execute one or more processes of the plurality of processes of a data processing workflow, for example, based on the specification of the workflow. In some embodiments, the techniques may create a pipeline execution record associated with executing a pipeline (e.g., flow of data through execution of one or more processes in the data processing workflow). The pipeline execution record may include, for each of the one or more executed processes, a process data record comprising the associated input data, output data, execution metadata, or some combination thereof. As such, the pipeline execution record contains data that records one or more instances of execution of a data processing workflow (or a portion thereof) and input/output data or other execution metadata associated with the execution(s).

In some embodiments, a pipeline execution record may be stored in a database in any suitable format. For example, the pipeline execution record may be represented in a graph and stored in a graph database. In some embodiments, the techniques can also enable a user (who created the pipeline execution record), or other users (who did not create the pipeline execution record) to query the pipeline execution record to see how the data flowed through the pipeline, how the pipeline was executed, or the configuration of the pipeline for a particular execution. In a non-limiting example, the techniques enable a user to search the pipeline execution record using a workflow query for one or more processes of a data processing workflow that match the workflow query. For example, whereas the pipeline execution record is a graph database, a workflow query may be represented in a sub-graph representing one or more processes of a portion of the graph database.

In response to a workflow query, one or more processes of the data processing workflow in the pipeline execution record may be matched to the workflow query. As a result, the techniques may output data associated with the one or more processes of the data processing workflow that match the workflow query, without re-executing the one or more processes of the data processing workflow. Alternatively, and/or additionally, when the workflow query does not match any process in the pipeline execution record, the techniques may execute one or more processes of the data processing workflow that are represented in the workflow query to generate the new output data.

In various embodiments, the techniques may display the pipeline execution record, for example, in a graph representation. The techniques may provide a user interface (e.g., graphical user interface) that receives user selection(s) defining at least a portion of the graph as the workflow query. Similarly, the techniques may also provide a user interface that enables the user to define a data processing workflow. For example, the techniques may provide a graphical user interface, and receive, via the graphical user interface, user selection(s) defining the one or more processes of the plurality of processes. In a non-limiting example, the user selection(s) may include selection(s) of one or more processes from a library of user selectable processes. The resulting data processing workflow defined by the user may be stored in a specification such as a specification file described herein above.

Whereas various embodiments have been described, it will be apparent to those of ordinary skill in the art that many more embodiments and implementations are possible. Accordingly, the embodiments described herein are examples, not the only possible embodiments and implementations. Furthermore, the advantages described above are not necessarily the only advantages, and it is not necessarily expected that all of the described advantages will be achieved with every embodiment.

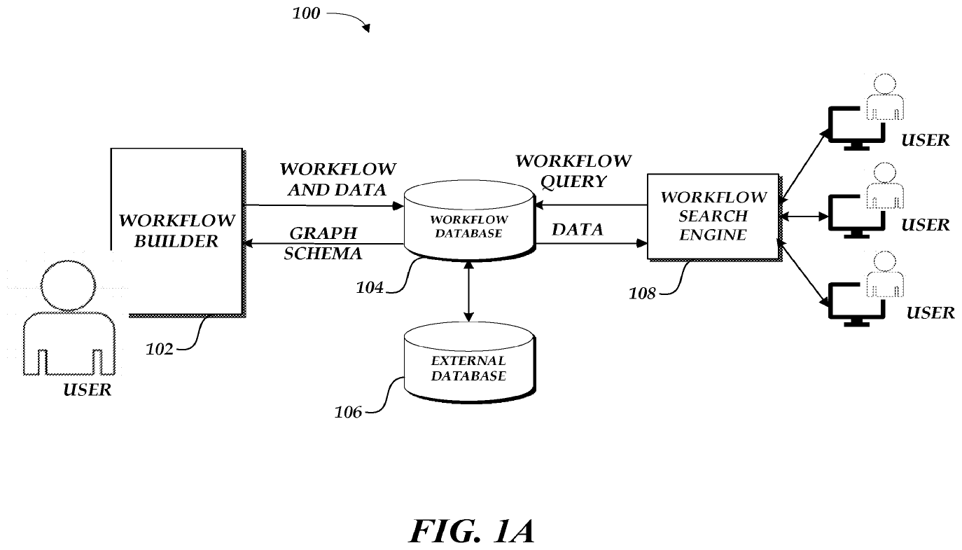

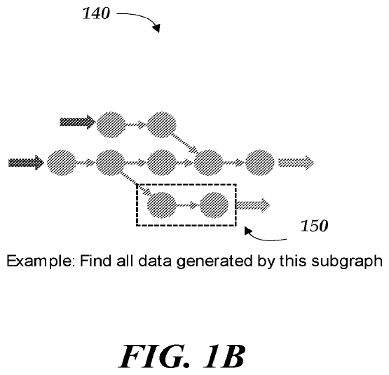

FIG. 1A is a diagram of a system for combined data and execution-driven pipeline, according to some embodiments. In some embodiments, workflow management system 100 may include a workflow builder configured to obtain a specification of a data processing workflow, where the workflow may include one or more processes of a plurality of processes. In some examples, the workflow builder may include a user interface configured to receive user selection(s) defining the one or more processes in the data processing workflow. In the data processing workflow, each of the one or more processes may be associated with respective input data and output data, and the one or more processes may be linked, where output data of one process may be provided as input to one or more other processes in the workflow.

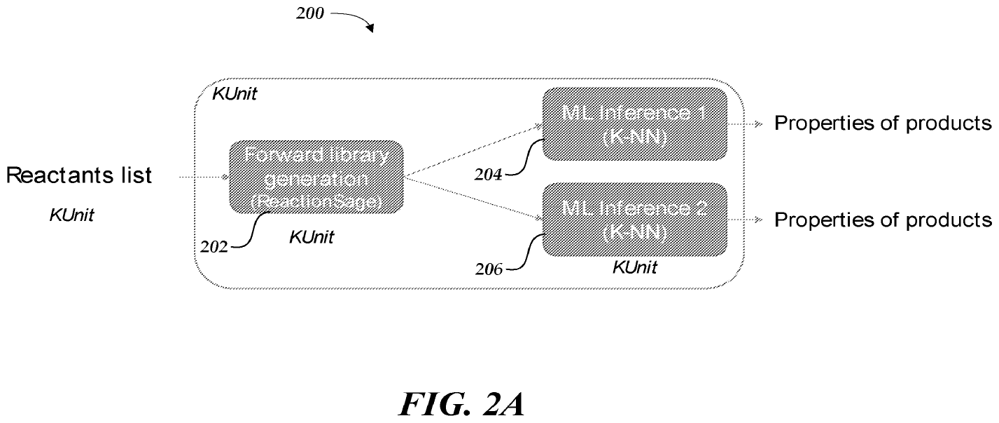

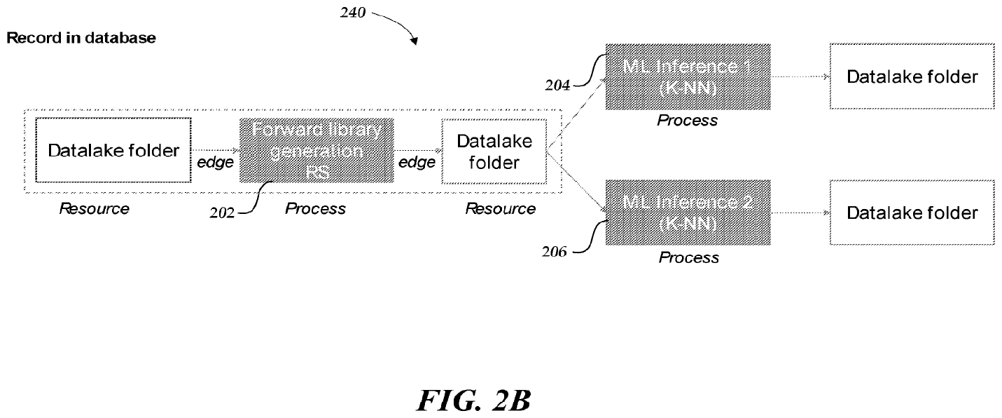

FIG. 2A illustrates multiple processes in an example data processing workflow defined by a user, according to some embodiments. As shown, a workflow 200 may include three processes 202, 204, 206 (referred to as KUnits in this example without intending to be limiting). In some embodiments, workflow 200 may be implemented in the workflow management system 100 (FIG. 1A). A process (e.g., a KUnit) may be a functional unit that can perform certain operations. As shown in FIG. 2A, process 202 may include a Forward library generation (Reaction Sage) that takes reactants list of products as input data. The Forward library generation process is linked to a first machine learning (ML) inference process 204 and a second ML inference process 206, where each of the ML inference processes 204, 206 takes the output of the Forward library generation process as input data, and generate a respective output, which includes the properties of the products.

FIG. 2B illustrates an example pipeline execution record 240 associated with the data processing workflow of FIG. 2A, according to some embodiments. In the example shown in FIG. 2A, each of the processes in the data processing workflow may be executed and generate intermediate data (to be provided as input data for other processes) or output data for the workflow.

Returning to FIG. 1A, system 100 may execute one or more processes of the plurality of processes of the workflow to generate, for each of the one or more processes, input data, output data, execution metadata, or some combination thereof. The system may generate a pipeline execution record, wherein the pipeline execution record comprises, for each of the one or more executed processes, a process data record comprising the associated input data, output data, execution metadata, or some combination thereof. In the example in FIGS. 2A and 2B, the system may generate the pipeline execution record 240 that includes the input data and output data of each of the processes of the data processing workflow 200, e.g., Forward library generation process 202, the first ML inference process 204 and the second ML inference process 206. The associated data in the pipeline execution record 240 may include the input data to the forward library generation process 202, the output data of the first ML inference process 204 and the second ML inference process 206, and any intermediate data. In the example shown, the intermediate data may include the output data of the forward library generation process 202, which is input to the first ML inference process 204 and the second ML inference process 206.

In some embodiments, the pipeline execution record may be represented in a graph representation, where the input/output data associated with each process in the data processing workflow may be represented by a respective node, and where each process in the data processing workflow may be represented by a link between the nodes. For example, with reference to FIG. 2B, the pipeline execution record may be represented by multiple nodes (shown as datalake folders) and multiple links between the nodes in a graph representation. For example, the forward library generation process 202 may be represented by a link between the node for the input data and the node for the output data associated with the forward library generation process. The first ML inference process 204 may be represented by a link between the node associated with the output data of the forward library generation process 202 and the node associated with the final output data (e.g., properties of the products) associated with the first ML inference process. Similarly, the second ML inference process 206 may be represented by a link between the node associated with the output data of the forward library generation process 202 and the node associated with the final output data (e.g., properties of the products) associated with the second ML inference process.

Returning to FIG. 1A, in some embodiments, the generated pipeline execution record may be stored in a workflow database 104, such as a graph database. In some examples, each data node may store the input/output data associated with a respective process in the data processing workflow. Alternatively, and/or additionally, each data node may include one or more pointers that reference to a data folder (e.g., data lake folder, as shown in FIG. 2B), where the data in the data folder may be downloaded from an external source, which can be from a software-based system (e.g., external database 106) and/or a hardware-based system. This representation of the pipeline execution record (e.g., in a graph representation) may enable the system to store and search any defined workflow together with the data associated with the workflow, where the data may result from a previous execution of the workflow using given input data (e.g., user defined input data).

Accordingly, system 100 may include a workflow search engine configured to receive, from one or more users, a workflow query, and use the workflow query to search the pipeline execution record for one or more processes of the data processing workflow that match the workflow query. The system may obtain from the pipeline execution record output data associated with the one or more processes of the data processing workflow that match the workflow query, and return the obtained output data to the user(s). This enables the user to quickly obtain the output data without the system re-executing any part of the data processing workflow.

In some embodiments, the user may identify one or more processes of a workflow the user would like to search. The user may use the identified one or more processes as a search query to search the associated pipeline execution record. In some examples, the search query may be in a graph representation, such as a sub-graph shown in FIG. 1B.

FIG. 1B illustrates an example of search query for searching a pipeline execution record by defining a graph search query, according to some embodiments. In some embodiments, the system may display the pipeline execution record 140 available for searching. For example, the pipeline execution record 140 may be displayed in a graph representation as described above. The system may receive a user selection defining a portion of the pipeline execution record (e.g., sub-graph 150). The sub-graph 150 may include one or more processes in the workflow. The system may search the pipeline execution record for one or more processes that match the one or more processes in the search query, and obtain the execution information (e.g., input/output and/or execution metadata) for the one or more processes that match the search query. For example, the output of the search may return the output data, and/or any intermediate data associated with the one or more processes that match the search query.

In some embodiments, the system may obtain data (e.g., input/out data, or other metadata) associated with execution of the matched process(es) in the workflow, where the data may be stored in the workflow database (see FIG. 1A). In other embodiments, the system may obtain new input data for the matched process(es) in the workflow and re-run the matched process(es) to generate new output data. For example, the system may receive an input data query in addition to the one or more processes for search in pipeline execution record. The system may determine one or more processes in the workflow that match the workflow query. In addition, the system may determine if the input data query matches input data associated with the one or more processes of the data processing workflow that match the workflow query. In response to determining a match of the input data query, the system may obtain the output data by retrieving output data associated with the one or more processes of the data processing workflow in the pipeline execution record that match the workflow query. Additionally, and/or alternatively, in response to determining a non-match of the input data query, the system may execute (re-run) the one or more processes of the data processing workflow that match the workflow query using the input data query, and generate the new output data. The system may obtain the new output data as the output data associated with the one or more processes of the data processing workflow that match the workflow query.

In the case of re-running the workflow with new input data, the system may create/append new pipeline execution record that includes the new output data associated with the workflow and the new input data. In an example implementation, the system may use a version control to manage different sets of data associated with a workflow (or a portion of a workflow). It is appreciated that the system main maintain a single pipeline execution record for each workflow, where the pipeline execution record may include multiple data sets each associated with an execution of a workflow (or a portion of a workflow). In some embodiments, the system may store multiple pipeline execution records associated with a workflow, where each record is associated with an execution of the workflow (or a portion of the workflow).

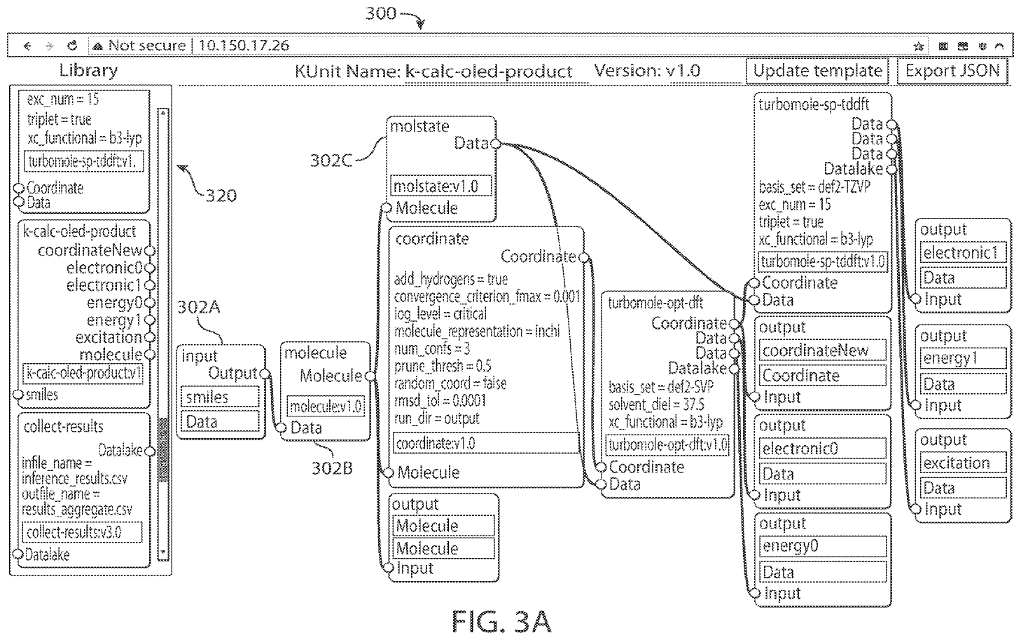

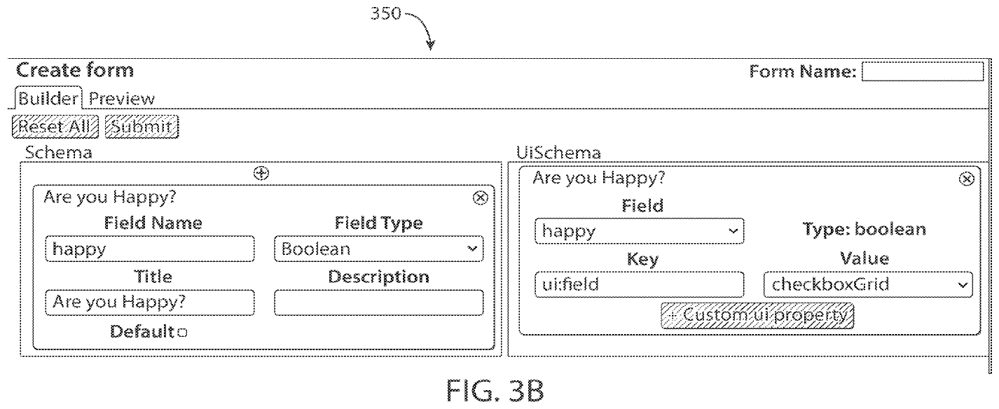

FIG. 3A illustrates an example graphical user interface that may be implemented in a workflow builder, according to some embodiments. For example, the graphical user interface 300 shown in FIG. 3A may be implemented in the workflow builder shown in FIG. 1A. In some embodiments, the workflow builder may receive user selection(s) for defining/building a data processing workflow and obtain a specification of the workflow. The user selection(s) may include selection(s) of one or more processes in a workflow and selection(s) of input/output data associated with each of the one or more processes. As shown in FIG. 3A, each of the boxes (302A, 302B, . . . ) in the user interface 300 of the workflow builder may be a process defining a function or a data block defining the input/output data associated with one or more processes. In some embodiments, a process box or a data block may be selected by the user from a library of processes or data blocks, such as 320 in FIG. 3A. The user interface 300 may enable users to connect the data blocks and the one or more processes to build a data processing workflow.

With further reference to FIG. 3A, the user may select a first data block 302A and connect it to a process box “molecule” (302B), where the first data block 302A may be configured to convert molecule data (e.g., in SMILES format) to an output data representing the molecule that may be provided to the process “molecule” (302B). The process “molecule” (302B) may be configured to receive the molecule data as input and generate output data that may be provided to a process “molstate” (302C). The process “molstate” 302C may receive the output data from the “molecule” process 302B and generate output data that include molecular states. The user may continue selecting additional process(es) and data block(s) to build the workflow. In the example shown in FIG. 3A, the workflow may be executed to generate a series of output data. For example, the output data may include energy property, excitation state, and coordinates of the input molecule. Although a graphical user interface is shown to enable a user to build a workflow, it is appreciated that other techniques may be possible. For example, the system may allow the user to define a data processing workflow using script language, using drag-and-drop operation, via reading from a workflow file, or a combination thereof.

In some embodiments, the system enables flexibility of data types associated with a process in a data processing workflow. FIG. 3B illustrates an example form builder 350 that may be implemented in a workflow builder of FIG. 1A, according to some embodiments. As shown, the system may allow a user to define/edit data formats (schema) that may be associated with a process. This allows flexibility of changing data schema(s) in the future, or support of older schema(s) or migration of older schema(s) to new schema(s).

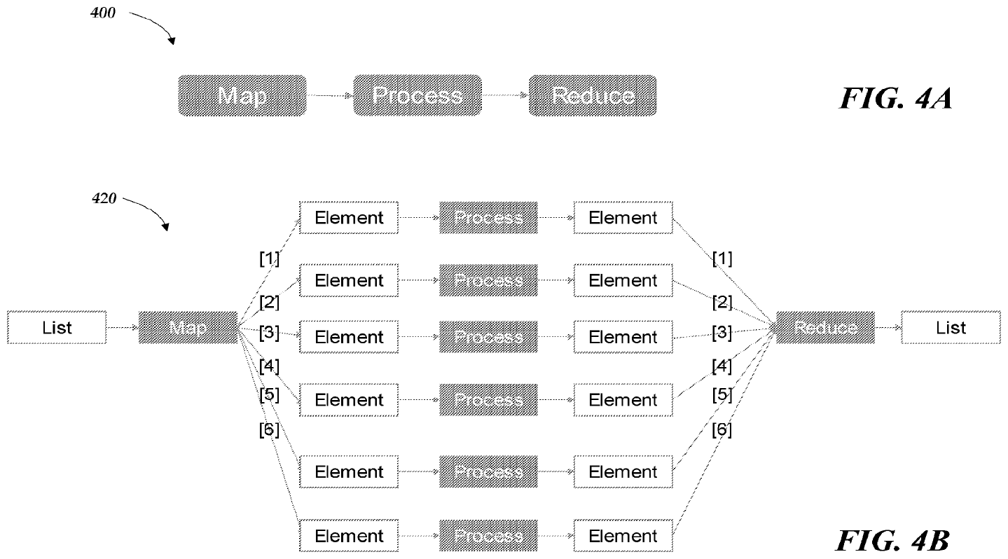

The various embodiments described herein may be implemented to build and search data processing workflows in various applications, such as the workflows shown in FIGS. 4A-7. In FIGS. 4A-7, the workflows are represented by respective pipeline execution records, which will be described in detail.

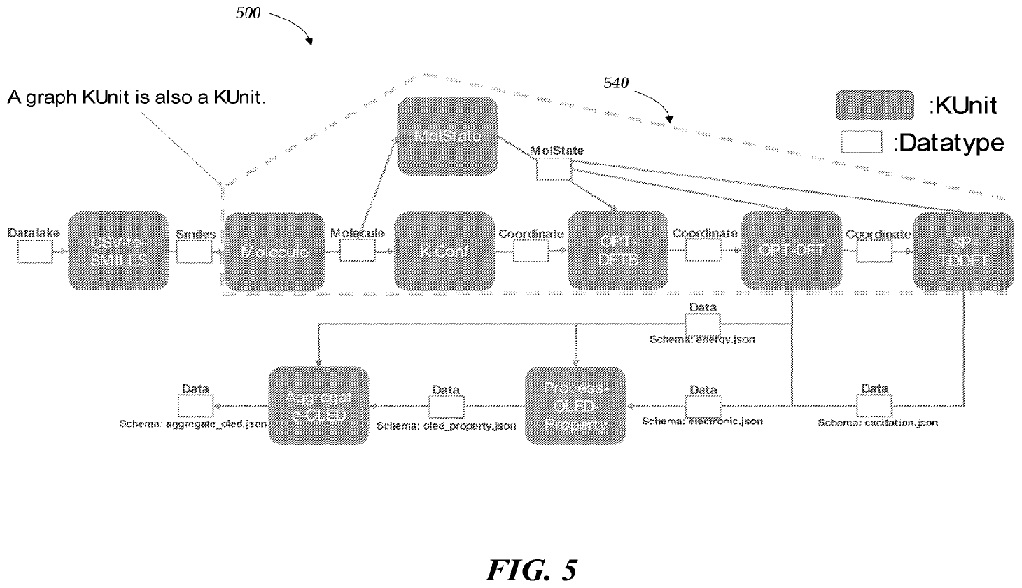

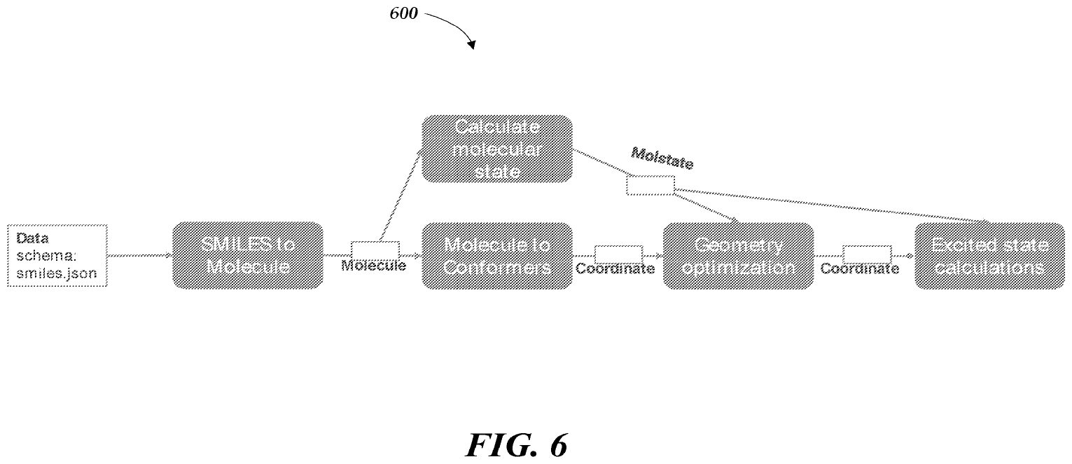

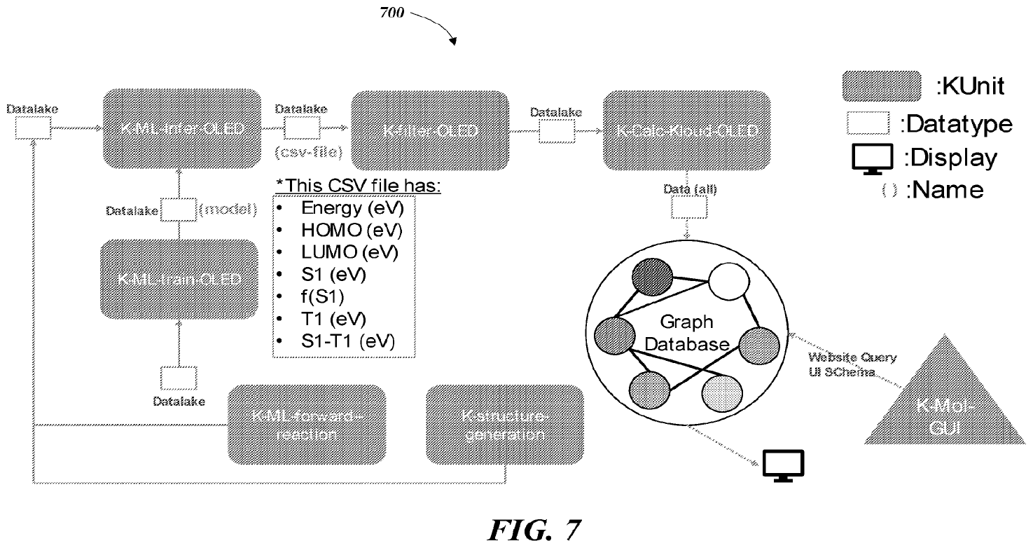

FIG. 4A illustrates multiple processes in an example map reduction data processing workflow 400, according to some embodiments. The workflow 400 may be built and executed in workflow management system 100 (FIG. 1A), in some embodiments. FIG. 4B illustrates an example pipeline execution record 420 associated with the data processing workflow 400 of FIG. 4A, according to some embodiments. FIG. 5 illustrates a pipeline execution record 500 associated with another example process for OLED, in which a portion of a data processing workflow includes a sub-workflow that includes one or more processes, according to some embodiments. FIG. 6 illustrates a pipeline execution record 600 associated with an example data processing workflows, according to some embodiments. FIG. 7 illustrates a pipeline execution record 700 associated with another example data processing workflow combined with machine learning training and prediction, according to some embodiments.

As illustrated, data associated with a process in a data processing workflow may include data or datalake. In some embodiments, data may include data itself or a pointer to a memory or external data source that stores the data. The datalake is an abstracted object for data storage that supports raw, native, or processed files (e.g., S3, Azure, Google Storage). The datalake itself may include metadata that allows for the use of search data (to a certain extent) without other components. A datalake may be available from a data storage device and/or platform (e.g., cloud storage) and can be downloadable locally (e.g., for faster execution).

In various examples, a process in a data processing workflow may be any of a machine learning process (e.g., machine learning training, machine learning inference), a molecule object creation process (e.g., having SMILES as input data and molecule object as output data), a molecule state process that defines an electronic state of the molecule that is needed for quantum chemistry processes (e.g., having molecule object as input data and molecule state as output data), a molecule-to-conformer process that will calculate 3D coordinates for number of lowest conformers of the input molecule (e.g., having molecule as input data and coordinates as output data), an geometry optimization using quantum chemistry density functional theory calculation (OPT-DFT) process (e.g., having coordinate and molecule state as input data, where the output data may include energy data, electronic data, coordinate data, or OPT-DFT datalake data for raw/unparsed outputs from the process).

In some embodiments, a process in a data processing workflow may also be a single point time dependent density functional theory quantum chemistry calculation to predict molecular electronic excited states SP-TDDFT (having coordinate and molecule state as input data, where the output data may have energy data, electronic data, excitation data, and/or SP-TDDFT datalake data). In some embodiments, a process in a data processing workflow may also include a geometry optimization process (having coordinates as input data, where the output data may also include coordinates), or an excited state calculation process (having coordinates as input data, where the output data include excited states). In some embodiments, a process in a data processing workflow may include a combination of multiple of processes. For example, as shown in FIG. 5, a process 540 in a pipeline execution record 500 may include multiple processes.

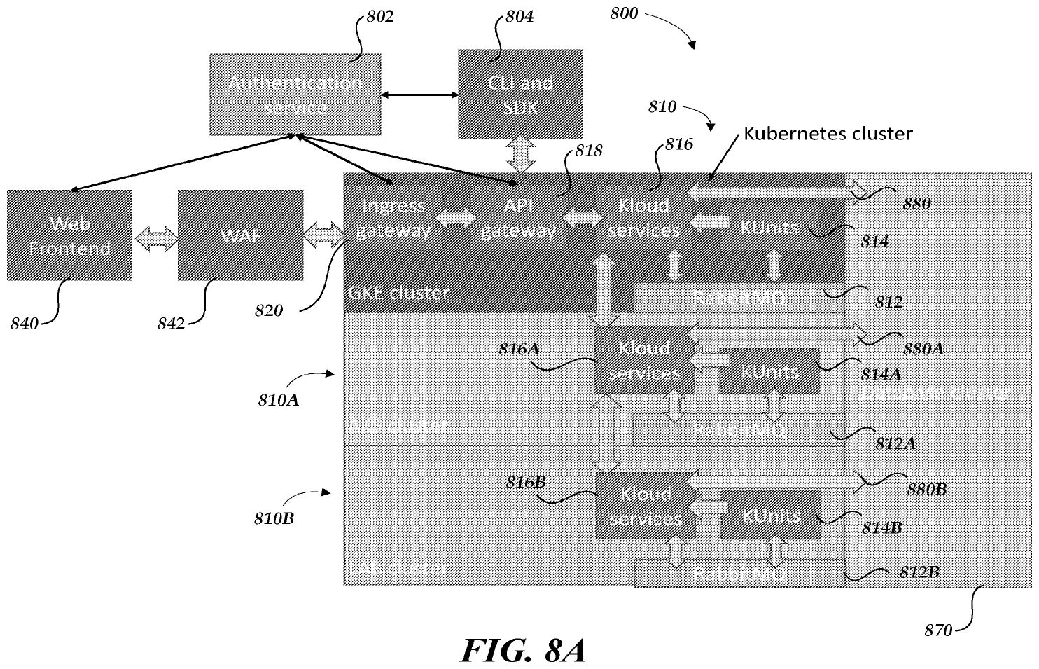

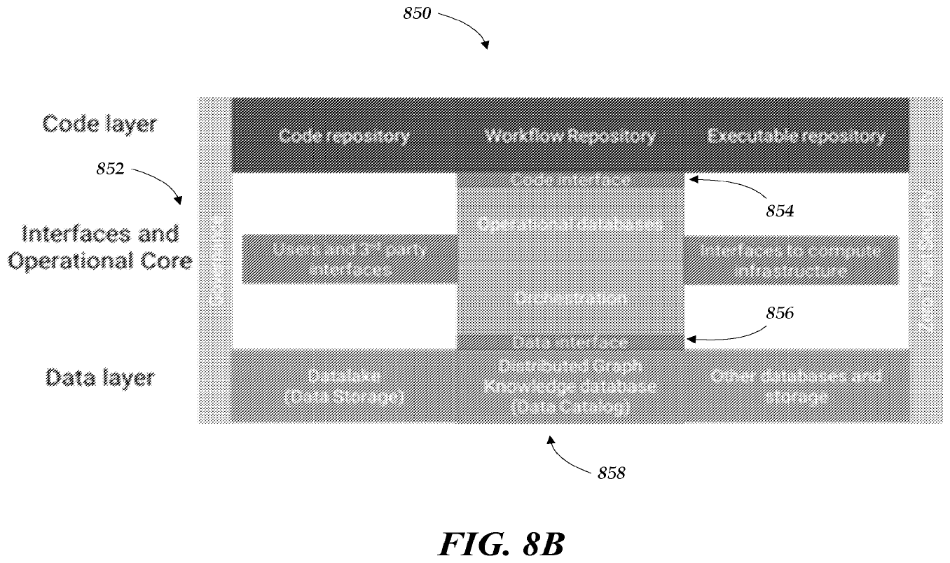

FIGS. 8A and 8B illustrate example architectures of a system that may implement one or more components of a system for combined data and execution-driven pipeline, according to some embodiments. In some embodiments, the architecture in FIGS. 8A and 8B may be implemented in a workflow management system, such as 100 in FIG. 1A. In some embodiments, the architecture may be implemented as SaaS. In some embodiments, container technologies may be used.

With reference to FIG. 8A, the workflow management system (e.g., 100 in FIG. 1A) is implemented using event-driven architecture 800, which includes backend components 810. In some embodiments, all backend components (e.g., 810) are deployed in a container orchestration platform (e.g., Kubernetes Clusters), where a message broker 812 (e.g., RabbitMQ) serves as a communication bus. As shown, KUnits 814 are executed in containers and their statuses and lifecycle are managed by “Kloud services” 816, which implements all the logics of KUnit management, access to the database and datalake, scaling compute resources, role-based control management, error handling, etc. Further shown in FIG. 8A, services (e.g., authentication service 802) may be communicative to the backend 810 components via developer API and CLI access (804) provided by the API gateway 818. Additionally, and/or alternatively, web application frontend (WAF) 840 may be communicative to the backend 810 via APIs for front-end interfaces that are provided via an ingress gateway 820 and protected by a Web Application Firewall 842.

With further reference to FIG. 8A, processes (e.g., KUnits) in a graph can be executed across different clusters (such as other cloud providers, and on-prem clusters) for users of various clusters to access. Additionally, pipeline execution records may be generated across different clusters and can be shared by the users of other clusters. For example, additional clusters (e.g., 810A, 810B) may similarly include their own processes (e.g., KUnits 814A, 814B) and deploy their own “Kloud services” (e.g., 816A, 816B) and messaging brokers (e.g., RabbitMQ 812A, 812B), respectively. Each additional cluster (e.g., 810A, 810B) and the cluster 810 is connected to a shared database cluster and/or datalake 870 via a respective bus (e.g., 880, 880A, 880B).

With reference to FIG. 8B, a data and workflow manager 850 may be implemented. The data and workflow manager may include several components and layers and may be implemented for distributed and heterogeneous workflows that are executed with cloud computing. The data and workflow manager 850 may include a central component, such as the operational core 852, which is responsible for global orchestration of all processes and exchange of data. For extensibility, reproducibility, and agility, the core 852 has extensible interfaces to code access and data access. In some embodiments, code interfaces 854 may provide a definition where code, workflows, and executables are stored (e.g., Git repositories, Container Repositories, Artifact Repositories). Depending on the type of code, the core may deploy and execute specific computing infrastructure (e.g., cloud or on-premise computing). Data interfaces 856 provide specifications for where data is stored and translated to be consumed or used by processes (code).

In some embodiments, governance in the data and workflow manager may provide appropriate controls for data, code, and execution. In some embodiments, all communications between components and services may be encrypted, authenticated, and authorized. These security schemes protect the system against threats that may exist both inside and outside the network so that the processes in the data processing workflow may be executed securely.

With further reference to FIG. 8B, in some embodiments, both data and metadata are abstracted. Various formats are supported and extensible. In some embodiments, the Knowledge Graph Database 858 may be the central data/metadata storage that combines information about data from different sources and the processes generated from this data. It stores the data in a structured format that is suitable to represent the relationships between processes and the data that they generate, along with additional metadata. Additionally, support of other data storage formats like Hadoop or Big Table can be connected via data interfaces 856.

In some embodiments, the main goal of the data and workflow manager is to support extensible abstraction for programming, execution, and query of heterogeneous workflows (mixed computational and experimental) and their associated data. The technical challenge of any collaborative platform that is scalable and intended for use by different organizations and people is to support ever-changing data formats (and schema), workflows and tools (e.g., both AI/ML and instrument). Accordingly, the system as described herein in various embodiments is designed according to the following assumptions and features: (i) Agility: flexibility of data schema, data and metadata schema will be changed in future, support for older schema or migration to new schema, end users can define their own schema, part of metadata collected automatically; (ii) Search and query: search by metadata and data, free text search, search by knowledge and workflow graphs, search by different users on the cloud; (iii) Security: data is immutable (append only), audit of data access and processing, authorization for data access, encryption of data; (iv) Reproducibility: Metadata has enough information that Data can be regenerated (with high probability or with a similar probabilistic distribution for random processes); and (v) Scalability: system can scale horizontally.

In some embodiments, machine learning, physical modeling, and experimental pipelines share many characteristics. The main difference for experimental pipelines is that they need to be synchronized with physical processes and objects in the lab. Therefore, using the same engine to execute and track both workflows provide the ability to rapidly introduce experimental and hypothesis-based workflows. This integration of workflows provides for richer searchability of the data and the construction of hypotheses and models from data generated by different workflows. Those workflows can be programmed by end users via simple YAML definition files, DSL (domain specific language), SDKs, and/or other tools. In some embodiments, the workflows may be tested, executed, and monitored via command line interface (CLI), Jupyter notebooks, web interfaces (such as what is shown in FIG. 7), and/or other suitable tools.

Various embodiments as described above may store data in a graph database (e.g., workflow database in FIG. 1A), where all data are linked to processes, and can be generated and/or used (if any). Data stored in the graph database can be queried based on the workflow graph or its subgraphs as part of the query. The workflows may be hierarchical (without limit) and can be queried at different hierarchy levels. Data may be immutable, not-deleted. As data are recorded in pipeline execution records as part of workflows, the various embodiments of the system described herein allow “history” or “data trail” query. Data may be abstracted, and may be indexed data with schema or without references to other data storages. Each process in the data processing workflow (e.g., a functional unit) can auto-scale, can run on different clusters, or can be of any workload. In some embodiments, workflows can communicate with instruments, user, run GPU or CPU programs, or interface with a developer environment. Pipeline execution records can be stored on the cloud and accessed (e.g., searched) by users on different clusters.

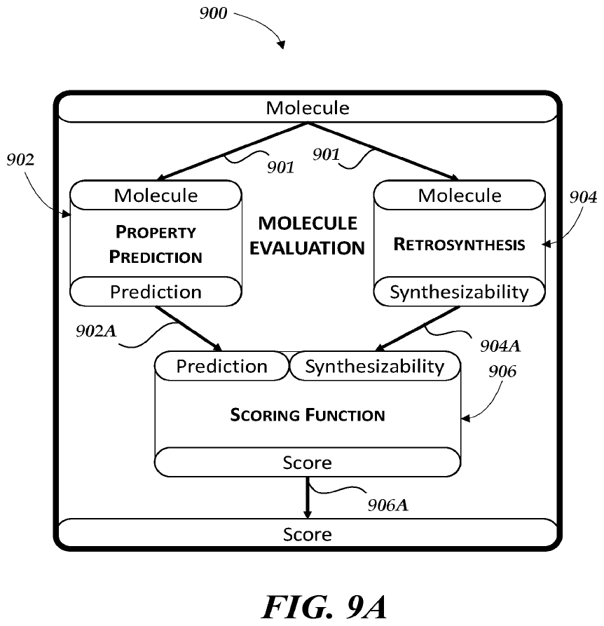

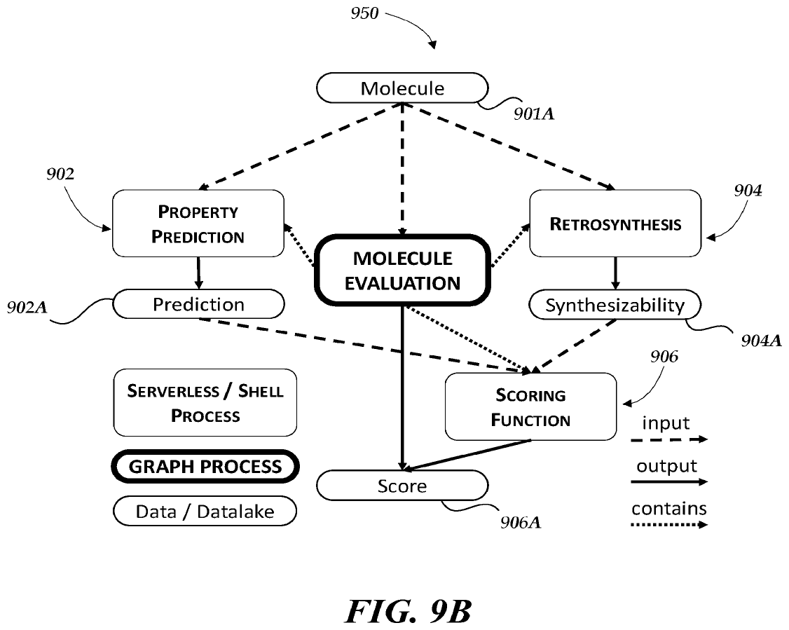

FIGS. 9-15 further illustrate additional example applications of various embodiments of a workflow management system described herein in the present disclosure. For example, FIG. 9A illustrates an example of molecule evaluation implemented in a workflow management system (e.g., 100 in FIG. 1A). A process 900 may be implemented as a KUnit, and configured to screen molecules for their properties and evaluate how easily molecules can be synthetized. Applications for this screening can be implemented in discovery of new materials and drugs. Process 900 may include three underlying processes 902, 904, 906. These processes may be serverless processes or shell KUnits. For example, process 902 may be a process for property prediction; process 904 may be a process for retrosynthesis; and process 906 may be a process for scoring. In some embodiments, processes “Property prediction” and “Retrosynthesis” (e.g., KUnits) may be executed on GPU instance and may have different (and mutually exclusive) software dependencies. As shown in FIG. 9A, each of the processes 902, 904, 906 is shown with its inputs at the top of the rounded rectangle and outputs at the bottom, in some examples, where the arrows show the connectivity between the processes. For example, the molecule 901 is sent to the first two processes 902, 904, and their results 902A and 904A are combined in the scoring function 906 to produce the overall score 906A. In these figures (e.g., FIGS. 9-15), the diagrams are shown with small caps names for serverless/shell processes and all-caps names for graph processes.

FIG. 9B illustrates an example of pipeline execution record in a graph database resulting from an execution of the workflow in FIG. 9A, according to some embodiments. The pipeline execution record 950 includes the underlying connectivity of the graph database resulting from a successful execution of a workflow (or a portion thereof). For example, the pipeline execution record 950 may be represented in a graph, with the nodes in the graph corresponding to each of the data used and processes run (e.g., molecule 901A, prediction result 902A, retrosynthesis result 904A, processes 902, 904, 906), and the edges in the graph corresponding to associations between the nodes. For example, as shown in FIG. 9B, the edges may be of different types: “input” edges (shown in dashed arrows) indicate the associations from data to process; “output” edges (shown in solid arrows) indicate the associations from process to data; and “contains” edges (shown in dotted arrows) indicate the associations from graphs to their child processes.

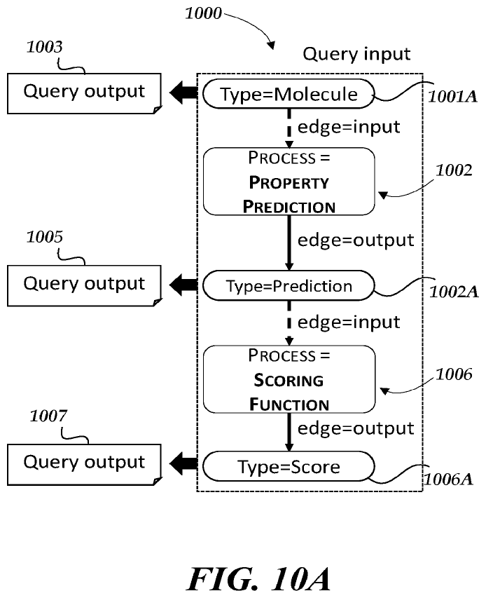

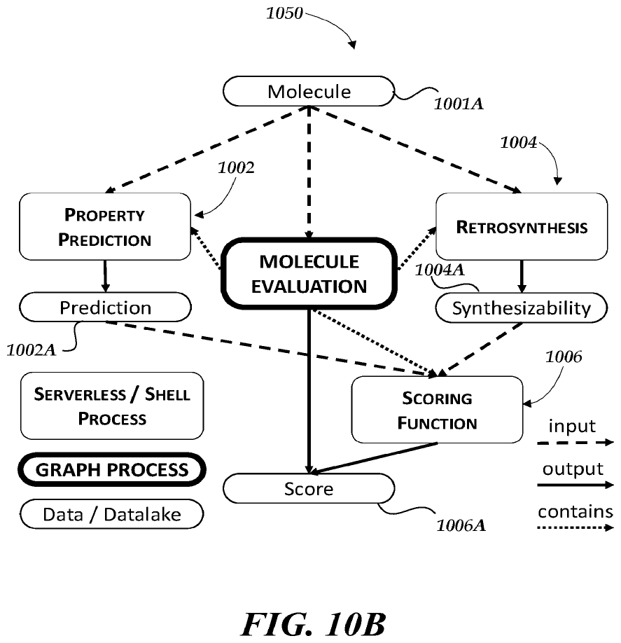

FIGS. 10A-10B illustrate an example graph database query based in part on a graph database resulting from an execution of a workflow such as what is shown in FIG. 9A, according to some embodiments. FIG. 10A illustrates a graph database query 1001 based on part of the graph 1050 in FIG. 10B that was used to generate the data. FIG. 10B, as similarly shown in FIG. 9B, shows a pipeline execution record 1050 resulting from execution of the workflow 900 in FIG. 9A. As shown, pipeline execution record 1050 is represented in a graph, with the nodes in the graph corresponding to each of the data used and processes run (e.g., molecule 1001A, prediction result 1002A, retrosynthesis result 1004A, processes 1002, 1004, 1006), and the edges in the graph corresponding to associations between the nodes. In this case, the query is intended to be used to find property predictions and the score of a given molecule. In some embodiments, a method for searching a pipeline execution record (with reference to FIGS. 10A and 10B) starts with a query input 1000 by searching all molecules that are input to processes named “Property Prediction” (e.g., 1002), this results in finding molecules (e.g., 1001A) as query output 1003. Then, the method continues searching outputs of that process (e.g., 1002) that has output data of type “Prediction” (e.g., 1002A). This results in query output 1005. The method for searching continues with searching “Scoring Function” processes (e.g., 1006) which take the given data record “Prediction” (e.g., 1002A) as input, then searching output edges that lead to data type “Score” (e.g., 1006A) as query output 1007. The filters at each stage ensure that the query continues to flow through the desired route instead of deviating to any of the other processes connected by the edges. In this example in FIG. 10A, the search returns the following data records “Molecule” (e.g., 1003), “Predictions” (e.g., 1005), and “Score” (e.g., 1007), which can be stored, for example, in a table.

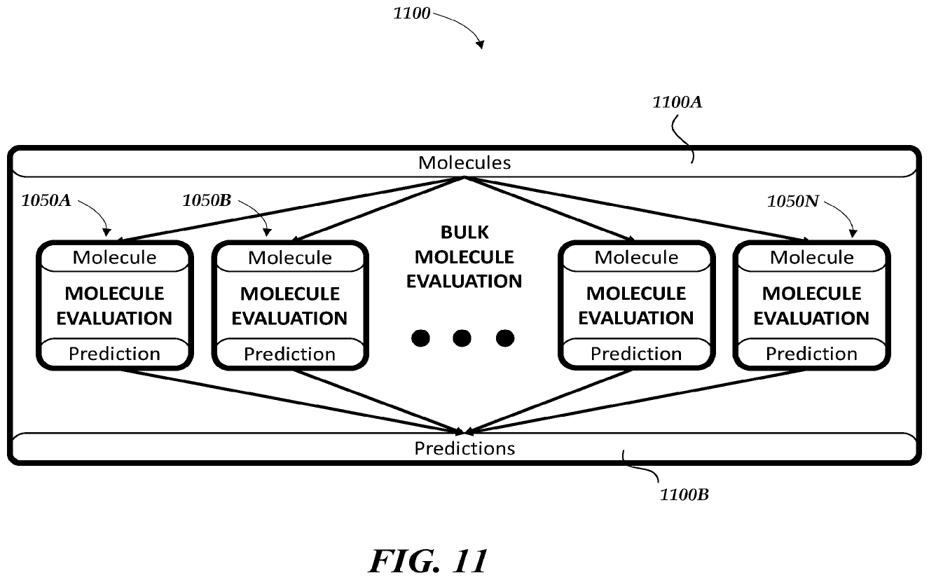

FIG. 11 illustrates examples of multiple molecules in parallel, according to some embodiments. In some embodiments, the various embodiments of the workflow management system (e.g., 100 in FIG. 1A) as described herein in the present disclosure supports a parallelized “map-reduce” framework. As shown in FIG. 11, “bulk molecule evaluation” process 1100 (e.g., implemented as a KUnit) is configured to perform molecule evaluation on multiple molecules (e.g., 1150A, 1150B . . . , 1150N) in parallel. The molecules 1100A are split apart, and each “Molecule Evaluation” graph (e.g., 1150A, 1150B . . . 1150N) runs in parallel, before all of the resulting predictions (e.g., 1100B) are collected together in the workflow management system.

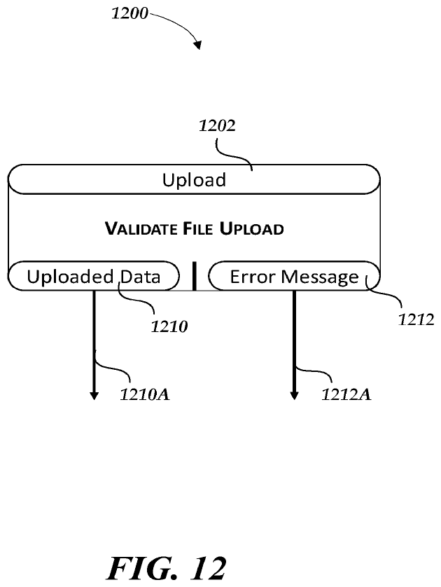

FIG. 12 illustrates example processing units of an example process 1200 in a workflow, according to some embodiments. In some embodiments, the example process 1200 may be any of the one or more processes (e.g., KUnits) in a data processing workflow such as what is described herein in the present disclosure. Individual KUnits can have multiple possible outputs (e.g., 1210, 1212) that are sent via different channels (e.g., 1210A, 1212A) depending on some condition in their computation. In this example, a serverless KUnit is used to validate user-provided file uploads (e.g., 1202). If the upload (e.g., 1202) is valid, then the output 1210 is a processed version of the uploaded data 1202. If upload 1202 is invalid, then an error message 1212 is generated instead. In a workflow including the process 1200 and other processes connecting to the process 1200, the output channels (e.g., 1210A, 1212A), in turn, can cause the other KUnits to run subsequently based on the output of process 1200.

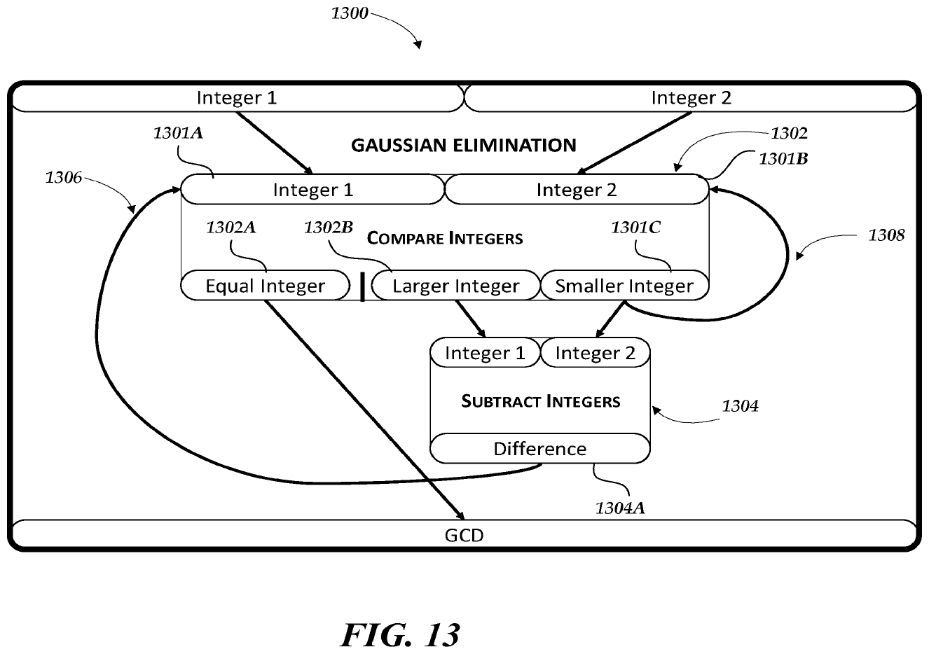

FIG. 13 illustrates an example recursive workflow, according to some embodiments. The recursive workflow 1300 may be implemented in various embodiments of the workflow management system described herein (e.g., 100 in FIG. 1A). In some embodiments, workflow 1300 implements the Gaussian elimination algorithm for determining the greatest common divisor of two integers. As shown, the workflow 1300 has separate processes (e.g., KUnits) for the subroutines of comparing the integers (process 1302) and subtracting the integers (process 1304). In a non-limiting implementation, two integers (e.g., integer 1, 1301A, and integer 2, 1301B) are compared, and if they are unequal, the difference 1304A between the larger integer 1302B and the smaller integer 1302C is recursively compared with the smaller one 1302C (through connections 1306, 1308). This process is repeated until the two integers (e.g., 1301A, 1301B) are equal, and that number 1302A is the greatest common divisor. As shown in FIG. 13, the recursive workflows includes one or more connections that go backwards from one child to another (or from one child to itself), such as connections 1306, 1308. This causes the “Compare Integers” process 1302 to repeat for whenever it gets triggered.

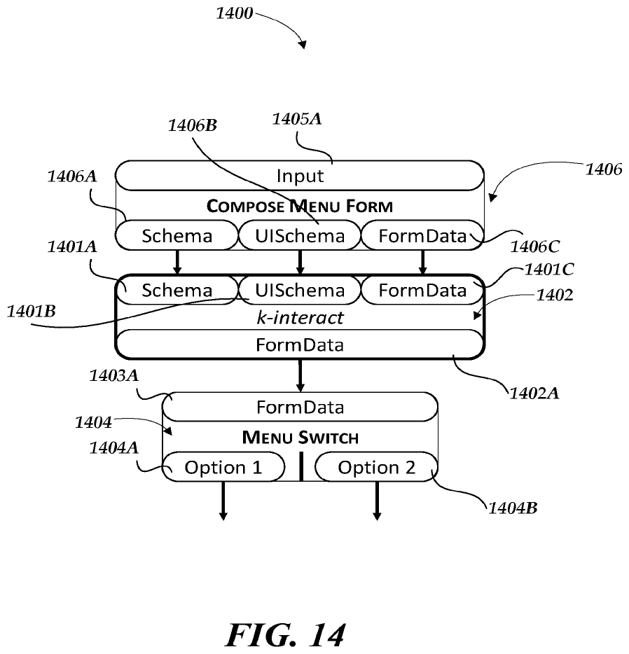

FIG. 14 illustrates an example of reconfiguring a workflow by adding one or more processes, according to some embodiments. A workflow 1400 may be implemented in various embodiments of the workflow management system described herein (e.g., 100 in FIG. 1A) and can be reconfigured, for example, by adding one or more processes. In FIG. 14, a user interaction process 1402 (e.g., a dedicated KUnit, “K-Interact”) may be added to workflow 1400. Interactions can be simple notifications, collecting structured inputs from users. Some of the input channels (e.g., 1401A, 1401B, 1401C) and output channels (e.g., 1402A) of the interaction process 1402 are shown. A “switch” process 1404 may be included that handles the logic of forms 1403A that ask the user to choose from a list of options (e.g., 1404A, 1404B). Additionally, and/or alternatively, a “compose” process 1406 is included that produces the inputs (e.g., 1406A, 1406B, 1406C) to the K-Interact form given input 1405A.

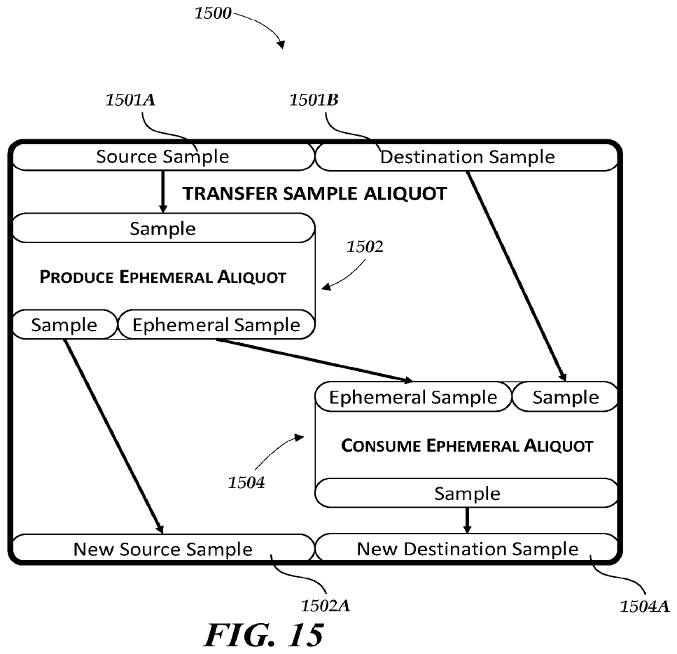

FIG. 15 illustrates an example of sample tracking in a laboratory implemented in a workflow 1500, according to some embodiments. In some embodiments, workflow 1500 may be implemented in various embodiments of the workflow management system described herein (e.g., 100 in FIG. 1A). As shown, the workflow management system as described herein can simplify the implementation of a complex process, such as “transfer sample aliquot.” Conventionally, “transfer sample aliquot” can be fairly complex in tracking the origins of each sample: When a portion of the source sample is added to the destination sample, the origins for the new source sample should not include the destination sample, but those for the new destination sample should include both of the original samples. In the example implementation, the workflow management system as described in the present disclosure can accomplish such workflow 1500 by utilizing a graph with two children (e.g., 1502, 1504) that produce (e.g., 1502) and consume an ephemeral sample (e.g., 1504). In such configuration, a portion of the source sample 1501A is added to the destination sample 1501B to generate a new destination sample 1504A, which includes both the source sample 1501A and destination sample 1501B, whereas the origins for the new source sample 1502A do not include the destination sample 1501B.

Accordingly, the systems and methods described in various embodiments of FIGS. 1-15 may provide advantages over other conventional systems to allow a unified system for computational and physical processes. For example, the systems and methods describe above may allow computational and AI processes to utilize a variety of hardware requirements (in building a workflow) and allow users to control instrumentation and samples tracking. In the systems and methods described above, data passed between processes is stored in association with one or more processes in the workflow. For example, a data processing workflow and data between the processes in the workflow may be stored in a graph database, as a pipeline execution record. The pipeline execution record for the workflow allows the user to query the data in any suitable stage in the workflow by the structure of the workflow (e.g., a graph or a sub-graph as search query). Furthermore, the systems and methods provided herein are particularly advantageous over convention systems such that data and chemistry workflows, which are complex and dynamically changing, may be scaled up.

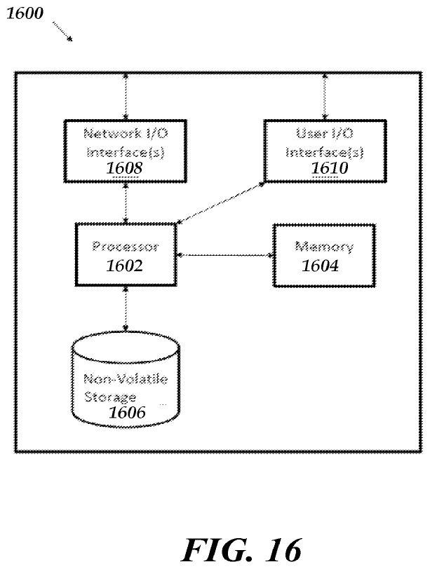

FIG. 16 shows an illustrative implementation of a computer device that may be used to perform any of the aspects of the techniques and embodiments disclosed herein, according to some embodiments. For example, the computer device 1600 may be installed in system 100 of FIG. 1A. The computer device 1600 may be configured to perform various methods and acts as described in FIGS. 1A-15. For example, the computer device 1600 can implement the workflow management system 100 or any components thereof (e.g., the workflow builder 102, workflow search engine 108) or any device associated with the users as shown in FIG. 1A. The computing device 1600 may include one or more computer hardware processors 1602 and non-transitory computer-readable storage media (e.g., memory 1604 and one or more non-volatile storage devices 1606). The processor(s) 1602 may control writing data to and reading data from (1) the memory 1604; and (2) the non-volatile storage device(s) 1606. To perform any of the functionality described herein, the processor(s) 1602 may execute one or more processor executable instructions stored in one or more non-transitory computer-readable storage media (e.g., the memory 1604), which may serve as non-transitory computer-readable storage media storing processor-executable instructions for execution by the processor(s) 1602. The computing device 1600 also includes network I/O interface(s) 1608 and user I/O interfaces 1610.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

Some embodiments are directed to a system for workflow management, the system comprising at least one processor, the at least one processor is configured to: obtain a specification of a data processing workflow comprising a plurality of processes, wherein each process is associated with input data and output data, and each process is further linked to one or more other processes of the workflow; execute one or more processes of the plurality of processes of the workflow to generate, for each of the one or more processes, input data, output data, execution metadata, or some combination thereof; and generate a pipeline execution record, wherein the pipeline execution record comprises, for each of the one or more executed processes, a process data record comprising the associated input data, output data, execution metadata, or some combination thereof.

In some embodiments, the process data record includes one or more pointers that reference to data in one or more external data sources.

In some embodiments, the process data records includes a plurality of datasets each associated with a respective execution of the one or more processes of the plurality of processes of the workflow.

In some embodiments, obtaining the specification of the data processing workflow comprises: receiving, via a graphical user interface, user selection defining the one or more processes of the plurality of processes.

In some embodiments, the user selection includes selection of one or more processes from a library of user selectable processes.

In some embodiments, the specification of the data processing workflow comprises a script file.

In some embodiments, the pipeline execution record is stored in a graph database.

In some embodiments, the at least one processor is further configured to: receive a workflow query; use the workflow query to search the pipeline execution record for one or more processes of the data processing workflow that match the workflow query; and obtain output data associated with the one or more processes of the data processing workflow that match the workflow query.

In some embodiments, the at least one processor is further configured to: receive an input data query; determine if the input data query matches input data associated with the one or more processes of the data processing workflow that match the workflow query; in response to determining a match of the input data query, obtain the output data by retrieving output data associated with the one or more processes of the data processing workflow in the pipeline execution record; and in response to determining a non-match of the input data query: (1) execute the one or more processes of the data processing workflow that match the workflow query to generate the new output data; and (2) obtain the new output data as the output data associated with the one or more processes of the data processing workflow that match the workflow query.

In some embodiments, the pipeline execution record is stored in a graph database; and the workflow query comprises a sub-graph.

In some embodiments, the at least one processor is further configured to: display the pipeline execution record in a graph; and receive user selection defining at least a portion of the graph as the workflow query.

In some embodiments, the process data record comprises one or more pointers that reference to data in one or more external data sources, and obtaining the output data associated with the one or more processes of the data processing workflow that match the workflow query comprises: retrieving the output data from at least one of the one or more external data sources using at least one of the one or more pointers.

Some embodiments are directed to a method for workflow management, the method comprising, using at least one processor: obtaining a specification of a data processing workflow comprising a plurality of processes, wherein each process is associated with input data and output data, and each process is further linked to one or more other processes of the workflow; executing one or more processes of the plurality of processes of the workflow to generate, for each of the one or more processes, input data, output data, execution metadata, or some combination thereof; and generating a pipeline execution record, wherein the pipeline execution record comprises, for each of the one or more executed processes, a process data record comprising the associated input data, output data, execution metadata, or some combination thereof.

In some embodiments, the process data record includes: one or more pointers that reference to data in one or more external data sources; or optionally, a plurality of datasets each associated with a respective execution of the one or more processes of the plurality of processes of the workflow.

In some embodiments, obtaining the specification of the data processing workflow comprises: receiving, via a graphical user interface, user selection defining the one or more processes of the plurality of processes.

In some embodiments, the user selection includes selection of one or more processes from a library of user selectable processes.

In some embodiments, the method further comprises: receiving a workflow query; using the workflow query to search the pipeline execution record for one or more processes of the data processing workflow that match the workflow query; and obtaining output data associated with the one or more processes of the data processing workflow that match the workflow query.

In some embodiments, the method further comprises: receiving an input data query; determining if the input data query matches input data associated with the one or more processes of the data processing workflow that match the workflow query; in response to determining a match of the input data query, obtain the output data by retrieving output data associated with the one or more processes of the data processing workflow in the pipeline execution record; and in response to determining a non-match of the input data query: (1) executing the one or more processes of the data processing workflow that match the workflow query to generate the new output data; and (2) obtaining the new output data as the output data associated with the one or more processes of the data processing workflow that match the workflow query.

Some embodiments are directed to a non-transitory computer-readable media comprising instructions that, when executed, cause at least one processor to perform operations comprising: obtaining a specification of a data processing workflow comprising a plurality of processes, wherein each process is associated with input data and output data, and each process is further linked to one or more other processes of the workflow; executing one or more processes of the plurality of processes of the workflow to generate, for each of the one or more processes, input data, output data, execution metadata, or some combination thereof; and generating a pipeline execution record, wherein the pipeline execution record comprises, for each of the one or more executed processes, a process data record comprising the associated input data, output data, execution metadata, or some combination thereof.

In some embodiments, the operations further comprise: receiving a workflow query; using the workflow query to search the pipeline execution record for one or more processes of the data processing workflow that match the workflow query; and obtaining output data associated with the one or more processes of the data processing workflow that match the workflow query.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

Various aspects are described in this disclosure, which include, but are not limited to, the following aspects:

1. A system comprising at least one processor, the at least one processor is configured to:
obtain a specification of a data processing workflow comprising a plurality of processes, wherein each process is associated with input data and output data, and each process is further linked to one or more other processes of the workflow;
execute one or more processes of the plurality of processes of the workflow to generate, for each of the one or more processes, input data, output data, execution metadata, or some combination thereof; and
generate a pipeline execution record, wherein the pipeline execution record comprises, for each of the one or more executed processes, a process data record comprising the associated input data, output data, execution metadata, or some combination thereof.

2. The system of claim 1, wherein the process data record includes one or more pointers that reference to data in one or more external data sources.

3. The system of claim 1, wherein the process data records includes a plurality of datasets each associated with a respective execution of the one or more processes of the plurality of processes of the workflow.

4. The system of claim 1, wherein obtaining the specification of the data processing workflow comprises:
receiving, via a graphical user interface, user selection defining the one or more processes of the plurality of processes.

5. The system of claim 4, wherein the user selection includes selection of one or more processes from a library of user selectable processes.

6. The system of claim 1, wherein the specification of the data processing workflow comprises a script file.

7. The system of claim 1, wherein the pipeline execution record is stored in a graph database.

8. The system of claim 1, wherein the at least one processor is further configured to:
receive a workflow query;
use the workflow query to search the pipeline execution record for one or more processes of the data processing workflow that match the workflow query; and
obtain output data associated with the one or more processes of the data processing workflow that match the workflow query.

9. The system of claim 8, wherein the at least one processor is further configured to:
receive an input data query;
determine if the input data query matches input data associated with the one or more processes of the data processing workflow that match the workflow query;
in response to determining a match of the input data query, obtain the output data by retrieving output data associated with the one or more processes of the data processing workflow in the pipeline execution record; and
in response to determining a non-match of the input data query:
execute the one or more processes of the data processing workflow that match the workflow query to generate the new output data; and
obtain the new output data as the output data associated with the one or more processes of the data processing workflow that match the workflow query.

10. The system of claim 8, wherein:
the pipeline execution record is stored in a graph database; and
the workflow query comprises a sub-graph.

11. The system of claim 8, wherein the at least one processor is further configured to:
display the pipeline execution record in a graph; and
receive user selection defining at least a portion of the graph as the workflow query.

12. The system of claim 8, wherein the process data record comprises one or more pointers that reference to data in one or more external data sources, and wherein obtaining the output data associated with the one or more processes of the data processing workflow that match the workflow query comprises:
retrieving the output data from at least one of the one or more external data sources using at least one of the one or more pointers.

13. A method comprising, using at least one processor:
obtaining a specification of a data processing workflow comprising a plurality of processes, wherein each process is associated with input data and output data, and each process is further linked to one or more other processes of the workflow;
executing one or more processes of the plurality of processes of the workflow to generate, for each of the one or more processes, input data, output data, execution metadata, or some combination thereof; and
generating a pipeline execution record, wherein the pipeline execution record comprises, for each of the one or more executed processes, a process data record comprising the associated input data, output data, execution metadata, or some combination thereof.

14. The method of claim 13, wherein the process data record includes:
one or more pointers that reference to data in one or more external data sources; or
optionally, a plurality of datasets each associated with a respective execution of the one or more processes of the plurality of processes of the workflow.

15. The method of claim 13, wherein obtaining the specification of the data processing workflow comprises:
receiving, via a graphical user interface, user selection defining the one or more processes of the plurality of processes.

16. The method of claim 15, wherein the user selection includes selection of one or more processes from a library of user selectable processes.

17. The method of claim 13, further comprising:
receiving a workflow query;
using the workflow query to search the pipeline execution record for one or more processes of the data processing workflow that match the workflow query; and
obtaining output data associated with the one or more processes of the data processing workflow that match the workflow query.

18. The method of claim 17, further comprising:
receiving an input data query;
determining if the input data query matches input data associated with the one or more processes of the data processing workflow that match the workflow query;
in response to determining a match of the input data query, obtain the output data by retrieving output data associated with the one or more processes of the data processing workflow in the pipeline execution record; and
in response to determining a non-match of the input data query:
executing the one or more processes of the data processing workflow that match the workflow query to generate the new output data; and
obtaining the new output data as the output data associated with the one or more processes of the data processing workflow that match the workflow query.

19. A non-transitory computer-readable media comprising instructions that, when executed, cause at least one processor to perform operations comprising:
obtaining a specification of a data processing workflow comprising a plurality of processes, wherein each process is associated with input data and output data, and each process is further linked to one or more other processes of the workflow;
executing one or more processes of the plurality of processes of the workflow to generate, for each of the one or more processes, input data, output data, execution metadata, or some combination thereof; and
generating a pipeline execution record, wherein the pipeline execution record comprises, for each of the one or more executed processes, a process data record comprising the associated input data, output data, execution metadata, or some combination thereof.

20. The non-transitory computer-readable media of claim 19, wherein the operations further comprise:
receiving a workflow query;
using the workflow query to search the pipeline execution record for one or more processes of the data processing workflow that match the workflow query; and
obtaining output data associated with the one or more processes of the data processing workflow that match the workflow query.
